(19) United States
(12) Patent Application Publication
(10) Pub. No.: US 2003/0227387 A1
(43) Pub. Date: Dec. 11, 2003

(54) Residential appliance with integrated water monitoring system

(76) Inventors: Royce Kimberlain, Garland, TX (US); Dale King, Garland, TX (US)

Correspondence Address: Royce Kimberlain, 2318 Royal Oaks Cr., Garland, TX, 75040, US

(21) Appl. No.: 10/145,409

(22) Filed: May 14, 2002

(51) Int. Cl. G08B 21/00

(52) U.S. Cl. 340/618; 340/604; 340/605

(57) ABSTRACT

The invention provides a self-monitoring residential appliance equipped with a control circuit included with appliance logic and also including a water detector communicatively coupled to the control circuit. The invention accordingly provides a cost effective solution that will allow a resident to prevent much of the damage previously faced as a result of water leaks and other appliance or fixture malfunction.

### TECHNICAL FIELD

Generally, the invention relates to the field of residential appliances, and more particularly, to water damage caused by water leaks in residential appliances.

### STATEMENT OF A PROBLEM ADDRESSED BY THIS INVENTION

Many appliances and plumbing fixtures such as hot water heaters, air conditioners, clothes washers, and dishwashers, for example, malfunction, resulting in water leakage and damage. For example, water supply hoses that come with most clothes washers tend to disintegrate over time, eventually rupturing and leaking large volumes of water. Also, water heaters can rust, crack, and become clogged due to mineral deposits in the storage reservoir. Sinks, basins, and tubs often overflow or have “pipe leaks.

With any of these malfunctions, water flows into unwanted areas and significant damage may occur. For example, walls, floors, carpets, furniture, personal computers and home filing systems are often damaged by water, resulting in significant costs to a resident and/or building owner. In addition to the water damage, there is often subsequent damage due to mold and mildew which can lead to unpleasant odors that make a residence unfit for habitation, or to “mold damage” claims on the insurance industry. In fact, several insurance carriers no longer insure homes in some states due to “black mold” claims.

These damages frequently are multiplied in multi-story dwellings as the water flows down into lower levels. Significant costs are frequently multiplied as carpets are replaced on more than one floor level. Two or more stories may need painting, light fixtures may need to be replaced, and ceiling tiles or other ceiling materials may need to be replaced. In addition, odor elimination may be required, which uses commercial fans and deodorant chemicals that add to the expense of uncontrolled moisture.

Currently, there are few methods for dealing with this problem. Although there are some expensive float ball options for air conditioners, this approach requires a trained technician to install the system. There are also crude water detection devices that detect water after is has been in the position to cause water damage. Accordingly, to overcome these and other disadvantages associated with water monitors, it would be advantageous to have a water monitoring system that provides a warning prior to water being in a position to cause damage. The invention disclosed herein provides such a system.

### SELECTED OVERVIEW OF SELECTED EMBODIMENTS

The invention provides technical and operational advantages as a residential appliance with an integrated water monitoring system. Generally, the invention is a self-monitoring residential appliance, such as a clothes washer, dishwasher, or preferably, a water heater that includes a control circuit integrated with appliance logic and a water detector communicatively coupled to the control circuit.

The appliance has within the control circuit, an alarm generator, a control logic coupled to the alarm generator, a power source interface coupled to the alarm generator, and a water detector communicatively coupled to the control logic and control circuit. Also included in the appliance is a water detector with two sensor prongs. One of the sensor prongs is coupled to a variable resistor for controlling current through the water.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a self-monitoring residential appliance including an appliance logic with an integrated control circuit;

FIG. 2 shows selected external input/output components of an appliance and integrated water monitoring system;

FIG. 3 illustrates physical relationships of selected components of an appliance and integrated water monitoring system;

FIG. 4 depicts one embodiment of an integrated appliance logic control system; and

FIG. 5 shows selected components of a water detector.

### AN EXEMPLARY EMBODIMENT OF A BEST MODE

The invention provides inventive embodiments that allow for water leak detection and warning of the water leak in appliances, and preferably in residential appliances. In one embodiment, the invention is a residential appliance integrated with a water detecting means. The water detecting means can be crafted or installed or sold separately, and is is communicatively coupled to a control circuit. In this exemplary embodiment, the invention incorporates an appliance adapted to receive a control circuit.

The invention accordingly provides a cost effective solution that alerts a resident or another user to mitigate the damage previously faced as a result of water leaks. In addition, the invention has many other advantages that are readily apparent to those of ordinary skill in the art. Interpretation Considerations When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment. Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning—” or “step” for —functioning—“in the claims section.

Exemplary Devices

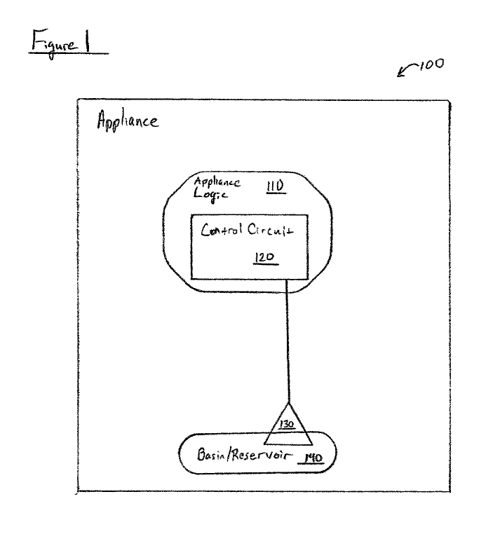

Features and advantages of the invention are more apparent when reading this technical specification in conjunction with the drawings. Accordingly, FIG. 1 shows an appliance and integrated water monitoring system 100 (the appliance). The appliance 100 is preferably a residential appliance, such as a water heater, clothes washer, dish washer, air conditioner, or other appliance. Of course, it should be understood that such a system can also be developed with any industrial appliance, such as a chill-water system, or a boiler, for example.

The appliance includes an appliance logic 110 that controls various appliance functions, such as temperature settings, start-cycles, or cycle selection. The appliance logic is adapted to couple to a control circuit 120, which provides function-specific circuitry. For example, the control circuit 120 may comprise the logic to detect a predetermined amount of water, to sound an alarm, or to adjust an alarm type or volume, for example. To detect sitting water in an appliance, the control circuit 120 is coupled to a water detector 130.

The water detector 130 is used to controll a voltage through the water detector 130. The water detector 130, in a preferred embodiment fits in an appliance basin/reservoir 140 to detect a water level in the basin/reservoir 140. Of course, a portion of the control circuit 120 may be physically located in the water detector without departing from the invention.

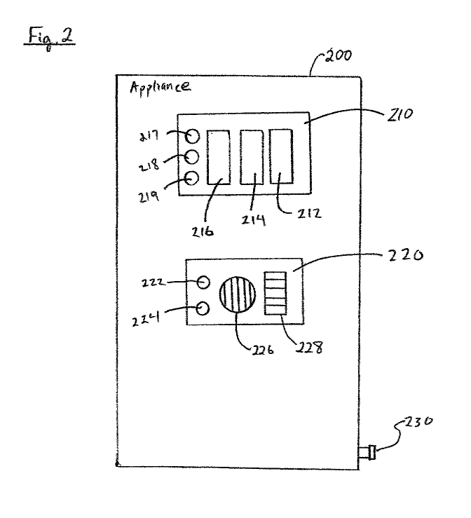

Some user-functions of the appliance 100 can be better understood by viewing the invention from a user point of view. Thus, FIG. 2 is an external view of an appliance with an integrated water monitoring system 200 (the appliance 200) depicting a control interface 210 for reporting system information, such as water heat, in a user-friendly format, and an alarm unit 220 that presents alarm information and controls to a user.

The control interface 210 contains the components for system information and control. For example, the control interface 210 maintains a moisture sensitivity control 212 that sets the amount of moisture necessary to activate an alarm condition. Sometimes, one may wish to set the moisture sensitivity control to a water detection setting in which an alarm sounds only when water is detected, while in other cases one may wish to set the sensitivity control to a moisture detection setting in which when even the mere presence of moisture is detected an alarm sounds.

The control interface also includes a water level control 214 that sets the depth of water necessary to activate an alarm condition. For example, the water level depth may be set to a “mere presence level” in which any water detection results in an alarm sounding, while other users may wish to set the alarm to sound only when the water level is detected to be an inch, two inches, or perhaps a predetermined depth below the surface of a basin.

Other controls 216-219 are preferably appliance controls. These provide control of appliance functions such as on/off, temperature control, cycle selection, or timers, for example. The alarm unit 220 includes an LED 228 for reporting alarm conditions for visual recognition, and a speaker 226 for reporting alarm conditions for aural recognition. The alarms, whether visual or aural, can be customized such that the volume, light intensity, intermittency of a sound or light, or a combination of the aforementioned variations may identify a specific condition detected. Thus, a user may know what is being detected without the need to physically inspect the alarm.

The volume of the aural alarm may be adjusted with a volume control 224. In addition, a reset switch 222 is provided to allow the alarm to be turn off and set to perform again, or to disable a “battery low” alarm for a predetermined period of time, such as 24 hours.

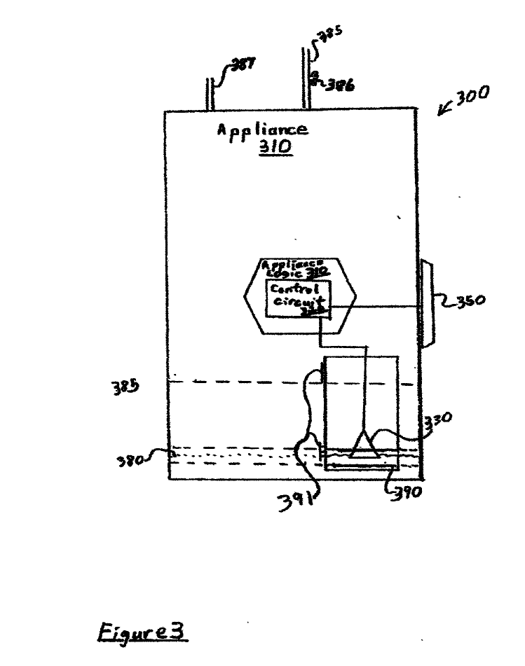

FIG. 3 shows an appliance and integrated water monitoring system (the appliance) 300 from a see-through profile that provides a more detailed representation of the appliance and integrated water monitoring system. The appliance 340 has a water inlet pipe 385, valve 386, and water outlet pipe 387. Accordingly, the appliance 340 may be illustrative of a hot water heater, a boiler, a washing machine, or a clothes washer, for example.

The control interface 350, discussed in more detail above, controls alarm conditions for the control circuit 320. In addition, the control interface 350 receives information representative of currently monitored systems, and statuses, from the control circuit 320. Accordingly, the control interface 350 translates appliance status and alarm information between a human usable form and a machine usable form. In addition, the control circuit exchanges command information and status information with an appliance logic 310. The appliance logic 310 is coupled to the control circuit and is used to monitor appliance conditions, and to control pure appliance (non-water monitoring or alarm) functions.

A water detector 330 (discussed in more detail below) detects at least a moisture level and a water level. Preferably, the control circuit 320 communicates with the water detector 330, and the water detector 330 is preferably situated in, or affixed to, an appliance basin such that the water detector 330 does not produce false alarms by grounding to the appliance basin 390. The appliance basin 390 is disposed below in a lower portion of the appliance 300, but need not be actually connected to the appliance 300. In one embodiment, access to the water detector 330 is achieved via a service door 390 that is mounted on hinges 391. In operation, water 380 is detected when it reaches a predetermined location of the water detector 330.

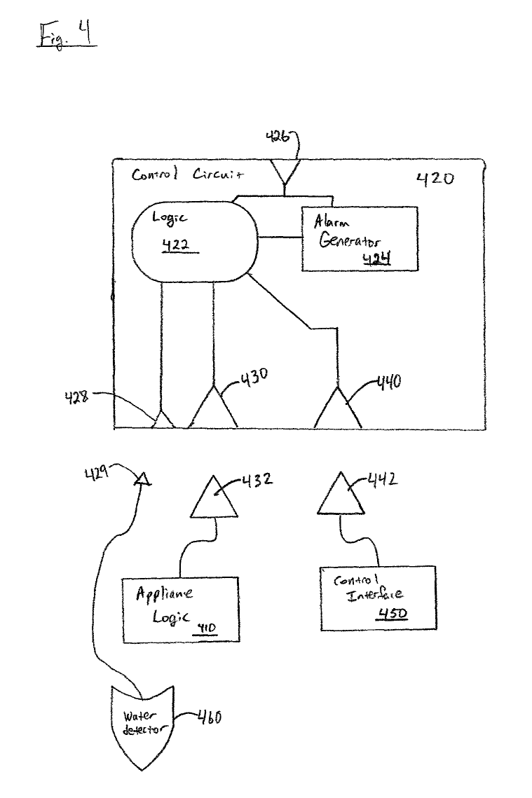

Advantages flow from integrating a control circuit with appliance logic. FIG. 4 illustrates a residential integrated appliance logic control system (control system) 400. In the control system 400 a control circuit 420 is capable of coupling with appliance logic 410 through a connector 430 and a receiver 432. Of course, it is understood that there are many types of connectors and connections and that the invention is not limited by the type of connector chosen. For example, the connector 430 and receiver 432 may be embodied as a male or female portion of a connection, as a bus/card connection, or as any other type of connection.

Coupling the control circuit 420 and the appliance logic 410 enable an integrated appliance logic-control circuit for an integrated water monitoring system. In addition, the control circuit 420 and the appliance logic 410 provide interrelated circuitry for detecting and for reporting a status of an appliance. Furthermore, the control circuit 420 and the appliance logic 410 may together control the functions of the appliance.

The control circuit 420 receives power from a power source interface 426 which may be direct wiring or a plug outlet for alternating current access, or leads for DC voltage access such as from a battery or a transformer/AC-DC converter (not shown). The control circuit 422 provides a power and control loop to an alarm generator 424 so that the sounding or lighting of the alarm may be controlled, and so that additional functionality can be provided to a user, such as the volume of the alarm, pitch of the alarm, the variations in pitch (including songs), or the timing of intermittency, for example.

Based on user inputs, a control circuit logic (the logic) 422 controls the sensitivity of a water detector, the volume of an alarm, the interpretation of a water level, or the type of alarm, for example. A control interface 450 is also connected to the logic 422 by a communicative coupling 442 and 440 that is similar to the communicative coupling 430/432. The control interface 450 translates between inputs and appliance status and alarm information in a human usable form, and an appliance usable format (typically, digital or analog signals). Also, a water detector 460 provides the inputs needed by the logic 422 to make determinations regarding water and moisture status.

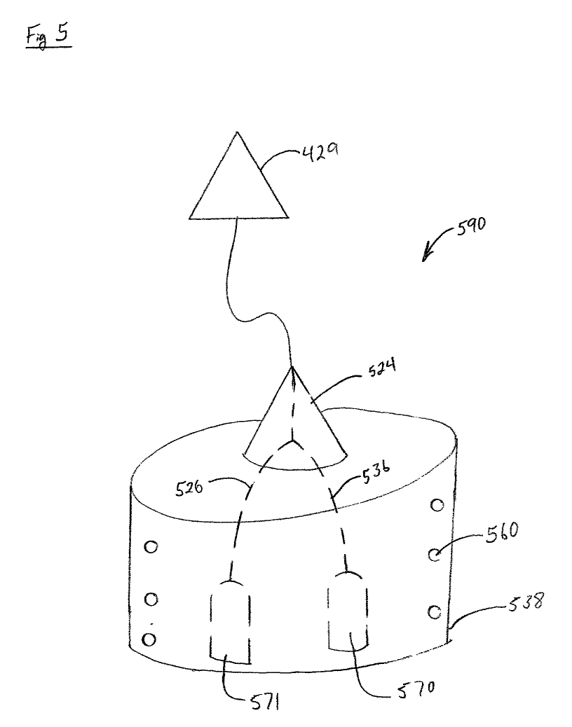

FIG. 5 shows selected components of a water detector 590. The communicative coupling 429 of FIG. 4 enables the water detector 590 to communicate with the logic 422 of the control circuit 420. Of course, the water detector 590 and the logic 422 may communicate wirelessly. In addition, it is apparent to those of ordinary skill in the art to place selected portions of the logic 422 in the water detector 590. Thus, the physical location of the control circuit may be distributed between the water monitor 590 and the logic 422, however, it is preferred to provide the entire logic 422 in the control circuit 420.

The water detector 590 is preferably has prongs 526, 536 which are housed in a container made of a nonconductive material, such as the nonconductive housing 538 of FIG. 5. The nonconductive housing 538, in one embodiment, includes a cap having a conical portion 524 through which wires fr om the communicative coupling 429 pass. In addition, the nonconductive housing 538 may include a pillbox-shaped portion 538 that has holes 560 for allowing water to penetrate the housing 538. In a preferred embodiment, the housing 538 is adapted to conform to the shape of a portion of an appliance that may accumulate water, such as a water heater basin.

The wires that pass through the conical cap 524 terminate into the first prong 526 and a second prong 536. The first prong 526 is shown having a variable resistor 571, and the second probe is shown having a second variable resistor 570. The resistor varies linearly with height, such that the resistor has a low resistance at a point of connection with a prong, and a high resistance at the opposite end. Thus when water at a first low level conducts a current through the prongs, a first voltage or current is generated across the prongs 526, 536. In a preferred embodiment, only one variable resistor is used. In another preferred embodiment, a water sensor prong is coated with an electrolyte that dissolves in water.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A self-monitoring residential appliance (the residential appliance), comprising:
an appliance having an appliance logic;
an control circuit integrated with the appliance logic, and
a water detector communicatively coupled to the control circuit.

2. The residential appliance of claim 1 wherein the water monitor is maintained in a water basin.

3. The residential appliance of claim 1 wherein the water detector maintains a portion of the control circuit for controlling a voltage through the water detector.

4. The residential appliance of claim 1 wherein the control circuit comprises:
an alarm generator;
a control logic coupled to the alarm generator;
a power source interface coupled to the alarm generator; and
a communicative coupling receptacle for connecting the control logic to the water detector.

5. The residential appliance of claim 4 wherein the alarm generator generates an audible alarm signal.

6. The residential appliance of claim 5, wherein the audible alarm generator is capable of generating a high-pitched frequency that is irritating to the human ear.

7. The residential appliance of claim 4, further comprising a logic coupling for communicatively coupling the control logic to the appliance logic.

8. The residential appliance of claim 1 wherein the water detector has a first water sensor prong and a second water sensor prong.

9. The residential appliance of claim 8 wherein the first water sensor prong is coupled to a variable resistor.

10. The residential appliance of claim 8 wherein the first water sensor prong is coated with an electrolyte that dissolves in water.

11. The residential appliance of claim 8 wherein the water detector is maintained in a housing that is adapted to integrally fit in an appliance location that is likely to hold water resulting from a leak.

12. The residential appliance of claim 8 wherein the appliance location is a water heater basin.

13. The residential appliance of claim 8 wherein the housing is a non-conductive and water penetrable housing.

14. A system of claim 8 wherein the housing is integrally molded with the basin.

15. The residential appliance of claim 4 wherein the alarm generator generates a visual alarm.

16. The residential appliance of claim 1, wherein the appliance is a water heater.

17. The residential appliance of claim 1, wherein the appliance is a clothes washer.

18. The residential appliance of claim 1, wherein the appliance is a dishwasher.

19. The residential appliance of claim 1, wherein the appliance is an air conditioner.

20. The residential appliance of claim 4, wherein the control logic adjusts the sensitivity of the control circuit based on an input from a control interface.
